(19) United States
(12) Patent Application Publication
(10) Pub. No.: US 2007/0090741 A1
(43) Pub. Date: Apr. 26, 2007

(54) Spacer and electron emission display including the spacer

(76) Inventor: Kang-Sik Jung, Suwon-si (KR)

Correspondence Address: Robert E. Bushnell, Suite 300, 1522 K Street, N.W., Washington, DC, 20005, US

(21) Appl. No.: 11/580,837

(22) Filed: Oct. 16, 2006

(30) Foreign Application Priority Data
Oct. 25, 2005 (KR) 10-2005-0100660

(51) Int. Cl. H01J 19/42; H01J 1/88; H01K 1/18

(52) U.S. Cl. 313/292

(57) ABSTRACT

A spacer that can be included in an electron emission display and that can effectively discharge secondary electrons includes a main body disposed between first and second substrates, a first coating layer formed on at least one of top and bottom surfaces of the main body, the top and bottom surfaces of the main body respectively contacting the first and second substrates, and a second coating layer formed on an outer surface of the main body and covering the first coating layer to contact the first and second substrates.

### CLAIM OF PRIORITY

This application makes reference to, incorporates the same herein, and claims all benefits accruing under 35 U.S.C.§119 from an application for SPACER AND ELECTRON EMISSION DISPLAY HAVING THE SPACER, earlier filed in the Korean Intellectual Property Office on the 25^{th} of Oct. 2005 and there duly assigned Serial No. 10-2005-0100660.

### BACKGROUND OF THE INVENTION

1. Field of the Invention

The present invention relates to a spacer disposed between two substrates forming a vacuum envelope for maintaining a gap between the substrates, and an electron emission display having the spacer.

2. Description of the Related Art

Generally, electron emission elements arrayed on electron emission devices are classified into those using hot cathodes as an electron emission source, and those using cold cathodes as the electron emission source.

There are several types of cold cathode electron emission elements, including Field Emitter Array (FEA) elements, Surface Conduction Emitter (SCE) elements, Metal-Insulator-Metal (MIM) elements, and Metal-Insulator-Semiconductor (MIS) elements.

The MIM element includes first and second metal layers and an insulation layer interposed between the first and second metal layers. In the MIM element, when a voltage is supplied between the first and second metal layers, electrons generated from the first metal layer reach the second metal layer through the insulation layer by a tunneling phenomenon. Among the electrons reaching the second metal layer, some electrons having energy levels higher than a work function of the second metal layer are emitted from the second metal layer.

The MIS element includes a metal layer, a semiconductor layer, and an insulation layer interposed between the metal layer and the semiconductor layer. In the MIS element, when a voltage is supplied between the metal layer and the semiconductor layer, electrons generated by the semiconductor layer reach the metal layer through the insulation layer by a tunneling phenomenon. Among the electrons reaching the metal layer, some electrons each having energy levels higher than a work function of the metal layer are emitted from the metal layer.

The SCE element includes first and second electrodes facing each other and a conductive layer disposed between the first and second electrodes. Fine cracks are formed on the conductive layer to form the electron emission regions. When a voltage is supplied to the first and second electrodes to allow a current to flow along a surface of the conductive layer, electrons are emitted from the electron emission regions.

The FEA elements use a theory in which, when a material having a relatively lower work function or a relatively large aspect ratio is used as the electron source, electrons are effectively emitted by an electric field in a vacuum. Recently, the electron emission regions have been formed of a material having a relatively lower work function or a relatively large aspect ratio, such as a molybdenum-based material, a silicon-based material, or a carbon-based material, such as carbon nanotubes, graphite, and diamond-like carbon, so that electrons can be effectively emitted when an electric field is supplied thereto in a vacuum. When the electron emission regions are formed of the molybdenum-base material or the silicon-based material, they are formed in a pointed tip structure.

The electron emission elements are arrayed on a substrate to form an electron emission device. The electron emission device is combined with another substrate having a light emission unit including phosphor layers and an anode electrode, thereby providing an electron emission display.

The conventional electron emission device includes electron emission regions and a plurality of driving electrodes functioning as scan and data electrodes. By the operation of the electron emission regions and the driving electrodes, the on/off operation of each pixel and an amount of electron emission are controlled. The electron emission display excites phosphor layers using the electrons emitted from the electron emission regions to display a predetermined image.

In addition, a plurality of spacers is disposed in the vacuum envelope to prevent the substrates from being damaged or broken by a pressure difference between the inside and outside of the vacuum envelope.

The spacers are exposed to the internal space of the vacuum envelope in which electrons emitted from the electron emission regions travel. Therefore, the spacers are positively or negatively charged by the electrons colliding therewith. The charged spacers can distort the electron beam path by attracting or repulsing the electrons, thereby deteriorating the color reproduction and luminance of the electron emission display.

In order to prevent the change of the electron beam path, the spacers can have a coating layer for discharging the electric charges accumulated on the spacer. However, since the coating layer is formed without considering a contact property thereof, the discharging efficiency thereof is deteriorated.

### SUMMARY OF THE INVENTION

The present invention provides a spacer that is configured to effectively discharge the electric charges accumulated on the spacer through a coating layer, and an electron emission display having the spacer.

In an exemplary embodiment of the present invention, a spacer is provided including: a main body arranged between first and second substrates; a first coating layer arranged on at least one of top and bottom surfaces of the main body, the top and bottom surfaces of the main body being arranged to respectively contact the first and second substrates; and a second coating layer arranged on an outer surface of the main body to cover the first coating layer, the second coating layer arranged to contact the first and second substrates.

A resistivity of the second coating layer is preferably greater than that of the first coating layer. A thickness of the first coating layer is preferably greater than that of the second coating layer. The first coating layer preferably includes a conductive material and the second coating layer preferably includes a resistive material. The conductive material is preferably selected from a group consisting of Ni, Cr, Mo, or an alloy thereof and the resistive material is preferably either Cr₂O₃ or Diamond-Like Carbon (DLC).

In another exemplary embodiment of the present invention, an electron emission display is provided including: first and second substrates facing each other to define a vacuum envelope; an electron emission unit arranged on the first substrate; a light emission unit arranged on the second substrate; and a spacer arranged between the electron emission unit and the light emission unit, the spacer including: a main body; a first coating layer arranged on at least one of top and bottom surfaces of the main body, the top and bottom surfaces of the main body being arranged to respectively contact the light emission unit and electron emission unit; and a second coating layer arranged on an outer surface of the main body to cover the first coating layer, the second coating layer arranged to contact the electron emission unit and light emission unit.

A resistivity of the second coating layer is preferably greater than that of the first coating layer. A thickness of the first coating layer is preferably greater than that of the second coating layer. The first coating layer preferably includes a conductive material and the second coating layer includes a resistive material. The conductive material is preferably selected from a group consisting of Ni, Cr, Mo, or an alloy thereof and the resistive material is preferably either Cr₂O₃ Diamond-Like Carbon (DLC).

The main body is preferably either a cylindrical-type or a wall-type.

The electron emission unit preferably includes an electron emission region and driving electrodes for controlling the electron emission region; and the light emission unit preferably includes a phosphor layer and an anode electrode arranged on a surface of the phosphor layer; and the second coating layer is preferably arranged to contact the driving electrode and the anode electrode.

The driving electrodes preferably include cathode and gate electrodes crossing each other and insulated from each other by an insulation layer and wherein the electron emission region is connected to the cathode electrode at a crossed region of the cathode and gate electrodes. The driving electrodes are preferably arranged on the first substrate and spaced apart from each other, and the electron emission region is preferably arranged between the first and second electrodes; and first and second conductive layers are preferably respectively arranged on the first substrate between the first electrode and the electron emission region and between the electron emission region and the second electrode and partly covering the first and second electrodes.

The electron emission region preferably includes a material selected from a group consisting of carbon nanotubes, graphite, graphite nanofibers, diamonds, diamond-like carbon, C₆₀, silicon nanowires, or a combination thereof.

The electron emission display preferably further includes a black layer arranged between sections of the phosphor layer, wherein a space is arranged within an area where the black layer is arranged.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partly broken, exploded perspective view of an electron emission display according to an embodiment of the present invention;

FIG. 2 is a partial sectional view of the electron emission display of FIG. 1;

FIG. 3 is a detailed sectional view of a portion around a spacer of the electron emission display of FIG. 1;

FIG. 4 is a view of a current flow on a surface of a spacer when the electron emission display of FIG. 1 is driven;

FIG. 5 is a view of a current flow on a surface of a spacer when an electron emission display according to a comparative example is driven; and

FIG. 6 is a partial sectional view of an electron emission display according to another embodiment of the present invention.

### DETAILED DESCRIPTION OF THE INVENTION

The present invention is described more fully below with reference to the accompanying drawings, in which exemplary embodiments of the invention are shown. The present invention can, however, be embodied in many different forms and should not be construed as being limited to the embodiments set forth herein; rather these embodiments are provided so that this disclosure will be thorough and complete, and will fully convey the concept of the present invention to those skilled in the art. Wherever possible, the same reference numbers will be used throughout the drawings to refer to the same or like parts.

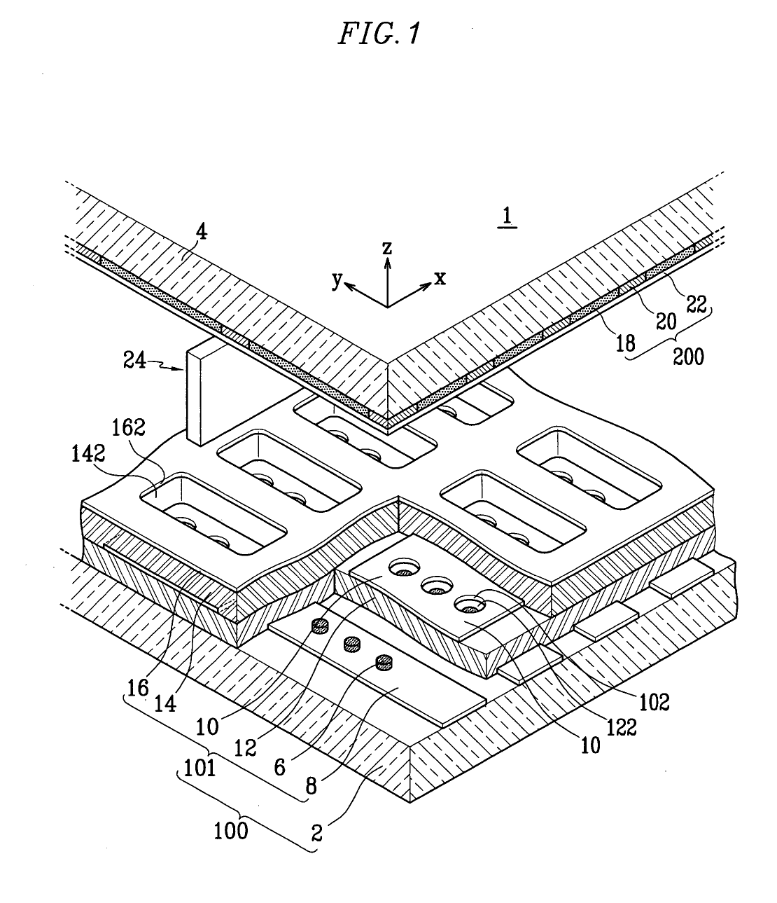

FIG. 1 through 3 are views of an electron emission display according to an embodiment of the present invention.

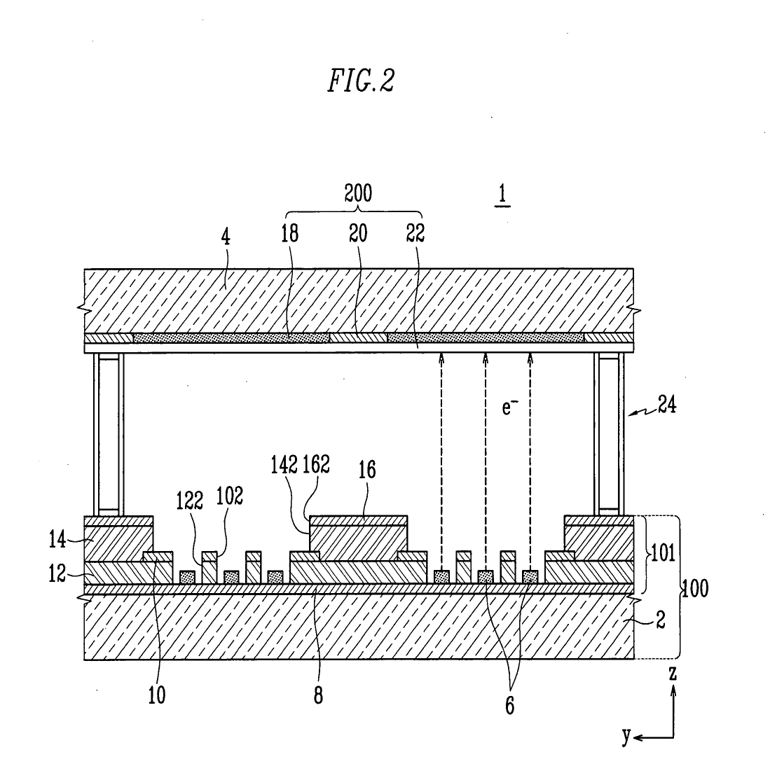

Referring first to FIGS. 1 and 2, an electron emission display 1 includes first and second substrates 2 and 4 facing each other and spaced apart from each other by a predetermined interval. A sealing member (not shown) is provided at the peripheries of the first and second substrates 2 and 4 to seal them together. The space defined by the first and second substrates and the sealing member is exhausted to form a vacuum envelope kept to a degree of vacuum of about 10⁻⁶ torr.

An electron emission unit 101 having an array of electron emission elements is provided on the first substrate 2. The electron emission unit 101 and the first substrate 2 form the electron emission device 100. The electron emission device 100 is combined with a light emission unit 200 provided on the second substrate 4, thereby forming the electron emission display 1.

The electron emission unit 101 includes electron emission regions 6 formed on the first substrate 2 and driving electrodes, such as cathode and gate electrodes 8 and 10, for controlling the electron emission of the electron emission regions 6.

In this embodiment, the cathode electrodes 8 are formed in a stripe pattern extending in a direction (the Y-axis in FIG. 1) of the first substrate 2 and a first insulation layer 12 is formed on the first substrate 2 to fully cover the cathode electrodes 8. Gate electrodes 10 are formed on the first insulation layer in a strip pattern running in a direction (the X-axis in FIG. 1) to cross the cathode electrodes 8 at right angles.

One or more electron emission regions 6 are formed on the cathode electrode 8 at each crossed region (hereinafter, referred as “unit pixel region”) of the cathode electrodes 8 and gate electrodes 10. Openings 122 and 102 corresponding to the electron emission regions 6 are formed in the first insulation layer 12 and gate electrodes 10 to expose the electron emission regions 6.

In this embodiment, although the electron emission regions 6 are formed in a circular shape and arranged in series along lengths of the cathode electrodes, the present invention is not limited thereto.

The electron emission regions 6 are formed of a material that emits electrons when an electric field is supplied thereto in a vacuum, such as a carbonaceous material or a nanometer-sized material. For example, the electron emission regions 6 can be formed of carbon nanotubes, graphite, graphite nanofibers, diamonds, diamond-like carbon, C₆₀, silicon nanowires, or a combination thereof.

In this embodiment, the gate electrode 10 is disposed above the cathode electrodes with the first insulation layer 12 interposed therebetween. However, the present invention is not limited thereto. That is, the cathode electrodes 8 can be disposed above the gate electrodes 10. The electron emission regions can then be formed on the first insulation layer while contacting a surface of the cathode electrodes.

A second insulation layer 14 is formed on the first insulation layer 12 to cover the gate electrodes 10 and a focusing electrode 16 is formed on the second insulation layer 14.

Openings 142 and 162 are formed in the focusing electrode 16 and second insulation layer 14 to expose the electron emission regions 6. The openings 142 and 162 are formed to correspond to the respective unit pixel regions where the cathode electrodes 6 cross the gate electrodes 10. The focusing electrode 16 can be formed on the entire surface of the first substrate 2 above the second insulation or formed in a predetermined pattern having a plurality of sections.

The light emission unit 200 includes phosphor layers 18 formed on a surface of the second substrate, which faces the first substrate 2, a black layer 20 for enhancing the contrast of the image formed between the phosphor layers 18, and an anode electrode layer 22, formed of a metal, such as aluminum, and arranged on the phosphor and black layers 18 and 20.

The anode electrode 22 functions to heighten the screen luminance by receiving a high voltage required for accelerating the electron beams and reflecting the visible light rays radiated from the phosphor layers 18 to the first substrate 2 toward the second substrate 4. The anode electrode 22 is disposed at the effective area of the second substrate 4.

The anode electrode 22 can be a transparent conductive layer formed of Indium Tin Oxide (ITO), for example, rather then being formed of metal. In such an arrangement, the anode electrode is formed on surfaces of the phosphor and black layers 18 and 20, which face the second substrate 4. Alternatively, the anode electrode 22 can include both metal and transparent conductive layers.

Disposed between the first and second substrates 2 and 4 are spacers 24 for uniformly maintaining a gap between the first and second substrates 2 and 4 against the outer forces applied to the vacuum envelope. The spacers 24 are disposed to correspond to the black layer 20 so as not to interfere with the light emission of the phosphor layers 18.

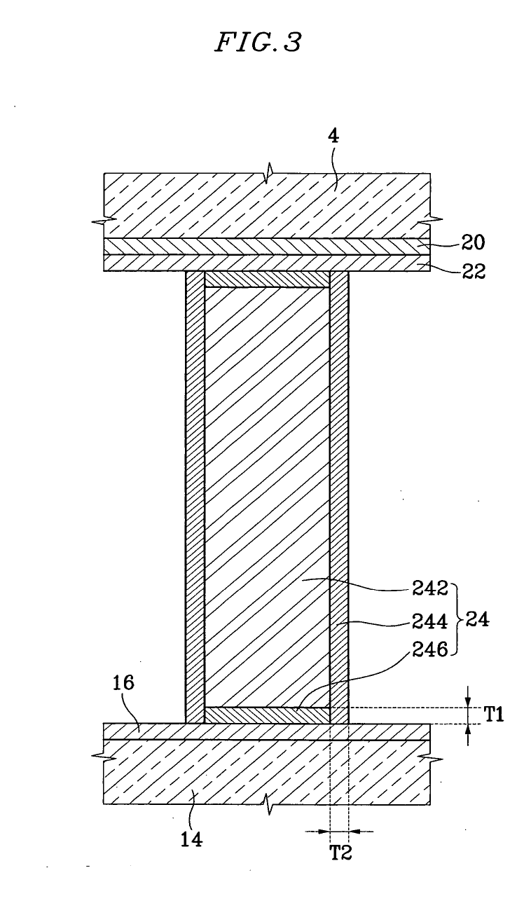

As shown in FIG. 3, each spacer 24 includes a main body 242 and first and second coating layers 244 and 246.

The main body 242 of the spacer 24 can be formed of ceramic or glass in a rectangular or circular cylinder-type or a wall-type. In this embodiment, the wall-type spacer is exampled.

The first coating layer 244 is formed on at least one of top and bottom surfaces of the main body 242, which contact the respective anode and focusing electrodes 22 and 16. The second coating layer 246 formed on a side surface of the main body 242 while covering the first coating layer 244. Therefore, the second coating layer 246 directly contacts the focusing and anode electrodes 16 and 22.

Therefore, a fine current flow occurs between the focusing and anode electrodes 16 and 22 through the second coating layer 246. When no focusing electrode is provided, the spacer 24 contacts the gate electrode 100. The fine current flow occurs between the gate and anode electrodes 10 and 22.

The contact shape between the first and second coating layers of the spacer 24 results from a coating order for forming the coating layers on the main body. That is, according to this embodiment of the present invention, the first coating layer 244 is first formed on the top and bottom surfaces of the main body 242 and then the second coating layer 246 is formed on the first coating layer 244 and side surface of the main body 242.

A resistivity R₂ of the second coating layer 246 can be less than that R₁ of the first coating layer (R₂>R₁) to allow the electric charges accumulated on the surface of the spacers 24 to effectively flow.

The first coating layer 244 can be formed of a conductive material having a relatively low resistivity and the second coating layer 246 can be formed of a resistive layer having a relatively high resistivity. That is, since the second coating layer 246 contacts the focusing and anode electrodes 16 and 22, the second coating layer 246 is formed of the resistive layer to prevent the short circuit between the focusing and anode electrodes 16 and 22. For example, the first coating layer 244 can be formed of a conductive material, such as Ni, Cr, Mo, or an alloy thereof. The second coating layer 244 can be formed of a resistive material, such as Cr₂O₃ or Diamond-Like Carbon (DLC).

A thickness T₁ of the first coating layer 244 can be greater than that T₂ of the second coating layer 246 (T₁>T₂). That is, as the thickness T₁ of the first coating layer 244 increases, the contact area between the first and second coating layers 244 and 246 increases and thus the contact resistance between the first and second coating layers 244 and 246 decreases.

The resistivities of the first and second coating layers 244 and 246 are set such that the fine current flow can be maintained between the focus and anode electrodes 16 and 22 to discharge the electric charges accumulated on the spacer 24 without the short circuit between the focus and anode electrodes 16 and 22.

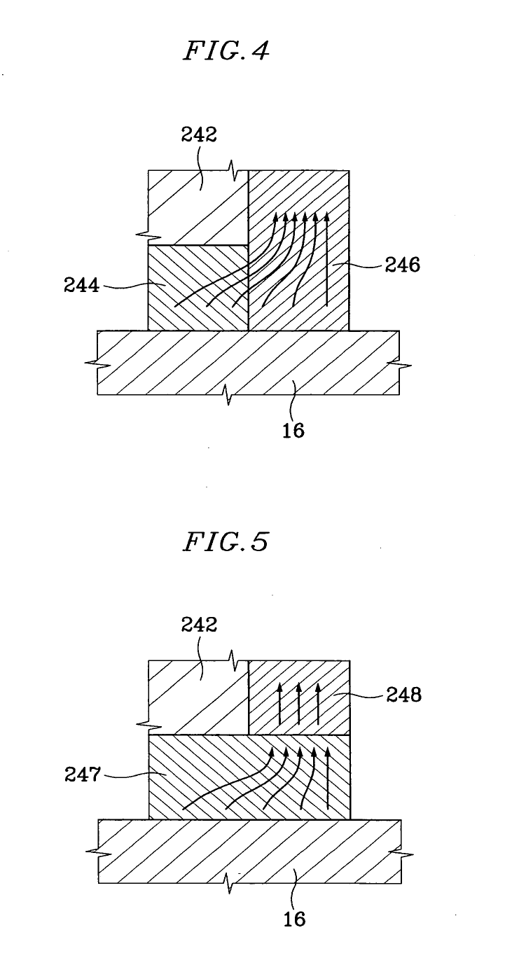

FIG. 4 is a view of the current flow on the surface of the spacer when the electron emission display of FIG. 1 is driven and FIG. 5 is a view of a current flow on a surface of a spacer when an electron emission display according to a comparative example is driven.

Referring to FIG. 4, the spacer 24 allows the current flow on the surface thereof to be effectively realized according to the contact property between the second coating layer 246 and the focusing electrode 16, a thickness ratio between the first and second coating layers 244 and 246, and resistivity properties of the first and second coating layers 244 and 246 of the present invention. That is, the current flows directly from the focusing electrode 16 to the first coasting layer 244 and from the focusing electrode 16 to the second coating layer 246 via the first coating layer 244. Therefore, the current crowding phenomenon where the current flows from the first coating layer 244 to the second coating layer 246 can be reduced.

Referring to FIG. 5, in a comparative example, a second coating layer 248 does not directly contact the focusing electrode 16 and thus the current flows only from the focusing electrode 16 to the second coating layer 248 via the first coating layer 247. Therefore, the current crowding phenomenon increases.

In FIGS. 4 and 5, the current flows are indicated by the arrows.

Although the electron emission display having the Field Emitter Array (FEA) elements is exampled in the above exemplary embodiment, the present invention is not limited to this example. That is, the present invention can be applied to an electron emission display having other types of electron emission elements such as Surface Conduction Emitter (SCE) elements, Metal-Insulator-Metal (MIM) elements or Metal-Insulator-Semiconductor (MIS) elements.

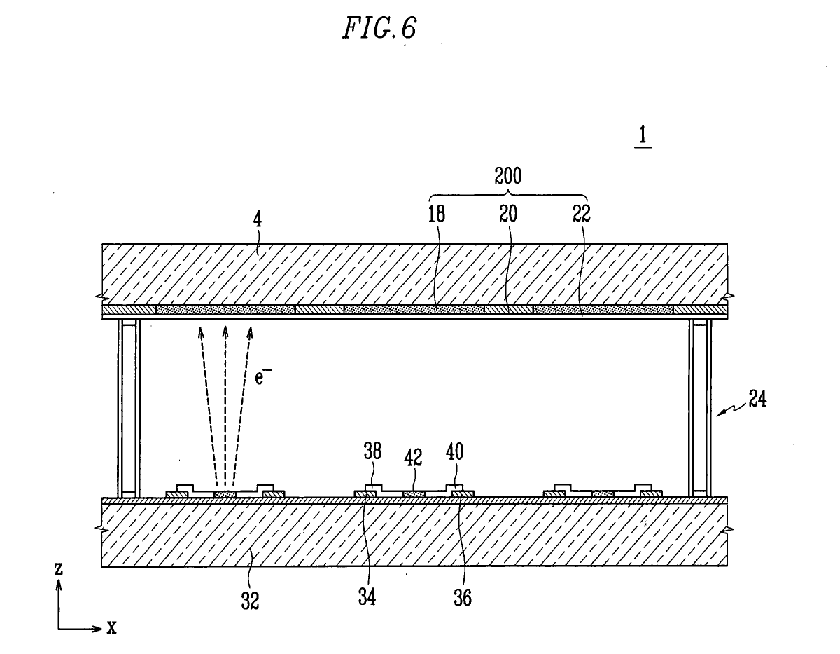

FIG. 6 is a view of an electron emission display having an array of SCE elements, according to another embodiment of the present invention. An electron emission display of this embodiment is identical to that of the foregoing embodiment except for the electron emission structure providing on the first substrate.

Referring to FIG. 6, first and second electrodes 34 and 36 are arranged on a first substrate 32 and spaced apart from each other. Electron emission regions 42 are formed between the first and second electrodes 34 and 36. First and second conductive layers 38 and 40 are respectively formed on the first substrate 32 between the first electrode 34 and the electron emission region 42 and between the electron emission region 42 and the second electrode 36 while partly covering the first and second electrodes 34 and 36. That is, the first and second electrodes 34 and 36 are electrically connected to the electron emission region 44 by the first and second conductive layers 38 and 40.

In this embodiment, the first and second electrodes 34 and 36 can be formed of a variety of conductive materials. The first and second conductive layers 38 and 40 can be a thin film formed of conductive particles, such as Ni, Au, Pt, or Pd.

The electron emission regions 42 can be formed of graphite carbon or a carbon compound. For example, the electron emission regions 440 can be formed of a material selected from the group consisting of carbon nanotubes, graphite, graphite nanofibers, diamonds, diamond-like carbon, fullerene (C₆₀), silicon nanowires, or a combination thereof.

In FIG. 6, parts identical to those of FIG. 2 are assigned like reference numerals and a detailed description thereof has been omitted herein.

According to the present invention, since the electron emission display has the spacer having an improved contact property, the current flow can be effective realized on the surface of the spacers, thereby effectively discharging the secondary electrons through the coating layers.

As a result, the electron beam distortion phenomenon can be decreased and thus the display quality of the electron emission display can be improved.

Although exemplary embodiments of the present invention have been described in detail hereinabove, it should be clearly understood that many variations and/or modifications of the basic inventive concept taught herein still fall within the spirit and scope of the present invention, as defined by the appended claims.

What is claimed is:

1. A spacer, comprising:
a main body arranged between first and second substrates;
a first coating layer arranged on at least one of top and bottom surfaces of the main body, the top and bottom surfaces of the main body being arranged to respectively contact the first and second substrates; and
a second coating layer arranged on an outer surface of the main body to cover the first coating layer, the second coating layer arranged to contact the first and second substrates.

2. The spacer of claim 1, wherein a resistivity of the second coating layer is greater than that of the first coating layer.

3. The spacer of claim 1, wherein a thickness of the first coating layer is greater than that of the second coating layer.

4. The spacer of claim 2, wherein the first coating layer comprises a conductive material and the second coating layer comprises a resistive material.

5. The spacer of claim 4, wherein the conductive material is selected from a group consisting of Ni, Cr, Mo, or an alloy thereof and the resistive material is either Cr₂O₃ or Diamond-Like Carbon (DLC).

6. An electron emission display, comprising:
first and second substrates facing each other to define a vacuum envelope;
an electron emission unit arranged on the first substrate;
a light emission unit arranged on the second substrate; and
a spacer arranged between the electron emission unit and the light emission unit, the spacer including:
a main body;
a first coating layer arranged on at least one of top and bottom surfaces of the main body, the top and bottom surfaces of the main body being arranged to respectively contact the light emission unit and electron emission unit; and
a second coating layer arranged on an outer surface of the main body to cover the first coating layer, the second coating layer arranged to contact the electron emission unit and light emission unit.

7. The electron emission display of claim 6, wherein a resistivity of the second coating layer is greater than that of the first coating layer.

8. The electron emission display of claim 7, wherein a thickness of the first coating layer is greater than that of the second coating layer.

9. The electron emission display of claim 7, wherein the first coating layer comprises a conductive material and the second coating layer comprises a resistive material.

10. The electron emission display of claim 9, wherein the conductive material is selected from a group consisting of Ni, Cr, Mo, or an alloy thereof and the resistive material is either Cr₂O₃ Diamond-Like Carbon (DLC).

11. The electron emission display of claim 6, wherein the main body is a cylindrical-type or a wall-type.

12. The electron emission display of claim 6, wherein the electron emission unit comprises an electron emission region and driving electrodes for controlling the electron emission region; and the light emission unit comprises a phosphor layer and an anode electrode arranged on a surface of the phosphor layer; and wherein the second coating layer is arranged to contact the driving electrode and the anode electrode.

13. The electron emission display of claim 12, wherein the driving electrodes include cathode and gate electrodes crossing each other and insulated from each other by an insulation layer and wherein the electron emission region is connected to the cathode electrode at a crossed region of the cathode and gate electrodes.

14. The electron emission display of claim 12, wherein the driving electrodes are arranged on the first substrate and spaced apart from each other, and the electron emission region is arranged between the first and second electrodes; and wherein first and second conductive layers are respectively arranged on the first substrate between the first electrode and the electron emission region and between the electron emission region and the second electrode and partly covering the first and second electrodes.

15. The electron emission display of claim 12, wherein the electron emission region includes a material selected from a group consisting of carbon nanotubes, graphite, graphite nanofibers, diamonds, diamond-like carbon, C₆₀, silicon nanowires, or a combination thereof.

16. The electron emission display of claim 12, further comprising a black layer arranged between sections of the phosphor layer, wherein a space is arranged within an area where the black layer is arranged.
